(19) United States
(12) Patent Application Publication
(10) Pub. No.: US 2002/0148623 A1
(43) Pub. Date: Oct. 17, 2002

(54) AC, DC interchangeable multipurpose combination power tool

(75) Inventor: Yaping Pan, Shanghai (CN)

Correspondence Address: GREER, BURNS & CRAIN, 300 S WACKER DR, 25TH FLOOR, CHICAGO, IL, 60606, US

(73) Assignee: Shanghai Xing Te Hao Industrial Co., Ltd.

(21) Appl. No.: 10/057,328

(22) Filed: Jan. 25, 2002

(30) Foreign Application Priority Data
Apr. 17, 2001 (CN) 01106000.X

(51) Int. Cl. B23B 33/00

(52) U.S. Cl. 173/217

(57) ABSTRACT

An AC, DC interchangeable multipurpose combination power tool, characterizes in that a main body of AC power tool and a main body of DC power tool are combined with a variety of tool heads in interchangeable way. The combination is accomplished via an outer spline arranged on the main body and an inner spline arranged on the tool head. The main body is provided with locking mechanism to tightly lock up the tool head. The combination power tool can be widely applied at working sites whether power supply network is available or not, and can satisfy different working requirements.

The present invention relates to a power tool, and more particularly to a combination power tool that a variety of tool heads can be interchangeably combined with the two main bodies utilizing an AC power source or a DC power source.

In the current market, power tools are rapidly developed, and different types of power tools are considerably increasing, and users have different requirements for power tools on different occasions or under different working circumstances. However, since each power tool has its dedicated purpose and almost all of power tools are of single service performance, users must be provided with a plurality of power tools to satisfy different needs under different conditions and under different working requirements. For example, when different operations such as drilling, sanding, grinding, and sawing are required, it is necessary to respectively utilize electric drill, electric grinder or electric saw to accomplish these tasks. Moreover, it is necessary to require AC power source or DC power source as power source in accordance with different working conditions at the working site. A power tool having interchangeable tool heads shown and disclosed in U.S. Pat. No. 6,179,579B1, a power tool assembly shown and disclosed in Chinese Patent No. 93220617.4 and a rechargeable multipurpose combination power tool shown and disclosed in Chinese Patent No.99239510.0, are all DC combination power tool and solve the multipurpose task via a variety of interchangeable tool heads. These power tools can be utilized at the working site where there is no electric power supply network after its battery pack is recharged, especially in an open country field. However, the supply time of the recharged battery pack is limited, they can not work for a long time. Subsequently, an AC multipurpose combination power tool is developed, this power tool is actually to provide a solution that main body of the AC power tool is combined with a variety of tool heads in order to accomplish various operations, but the electric extension cord would be necessary when operation is carried out in an open country or at working site far away from the electrical power supply network, otherwise, AC power tool can not be used. It is possible to lead to inconvenience, unsafety etc when the electric extension cord is used. In general, two separate sets of multipurpose power tools utilizing AC power source and DC power source have to be provided to meet the above-mentioned different working requirements.

An principal object of the present invention is to provide an AC, DC interchangeable multipurpose combination power tool which can accomplish different operations such as drilling, sanding, grinding and sawing etc, in accordance with the various working conditions and various demands of function, and may be used at the working site, no matter whether power supply network is available or not, or at the working site far from the power supply network.

To achieve the above object of the present invention, an AC, DC interchangeable multipurpose combination power tool comprising a main body of AC power tool and a main body of DC power tool, the main bodies of the AC power tool and the DC power tool respectively couples with a variety of tool heads in an interchangeable way. Both main bodies of the AC power tool and the DC power tool are provided with an outer spline arranged on an extension end of a main shaft of the electromotor, and an axis of the outer spline is in alignment with that of the main shaft. A variety of tool heads are all provided with an inner spline, one end of which meshes with the outer spline of the main body, the other end of which is connected with an output shaft of the tool head, an axis of the output shaft is in alignment with that of the main shaft of the electromotor. The main bodies of the AC power tool and the DC power tool are both provided with the same locking mechanism, which is able to lock up the variety of the tool heads for tight combination. The above variety of tool heads can be tool members used for drilling, sanding, grinding, and sawing etc.

The present invention comprises two interchangeable main bodies that are provided with the same locking mechanism in order to interchangeably connect with a variety of multipurpose tool heads, and share a variety of multipurpose tool heads to meet the different requirements on different working occasions. When the working site is far away from the power supply network, the battery-type DC power tool can be utilized. Alternatively, the AC power tool can be utilized at the working site where power supply network is available. It can make the characteristics of the AC power tool and the DC power tool more apparent, both economical and portable to the users.

A preferred embodiment of the present invention will be described in detail with reference to the accompanying drawings:

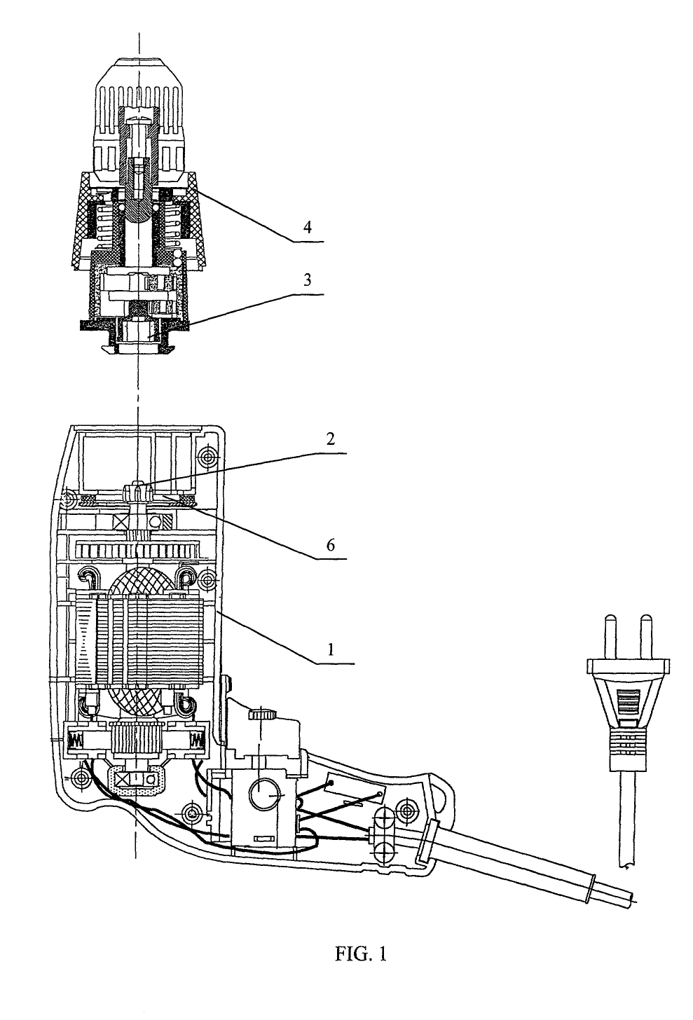

FIG. 1 is an exploded structural view of the main body and the tool head of the AC power tool.

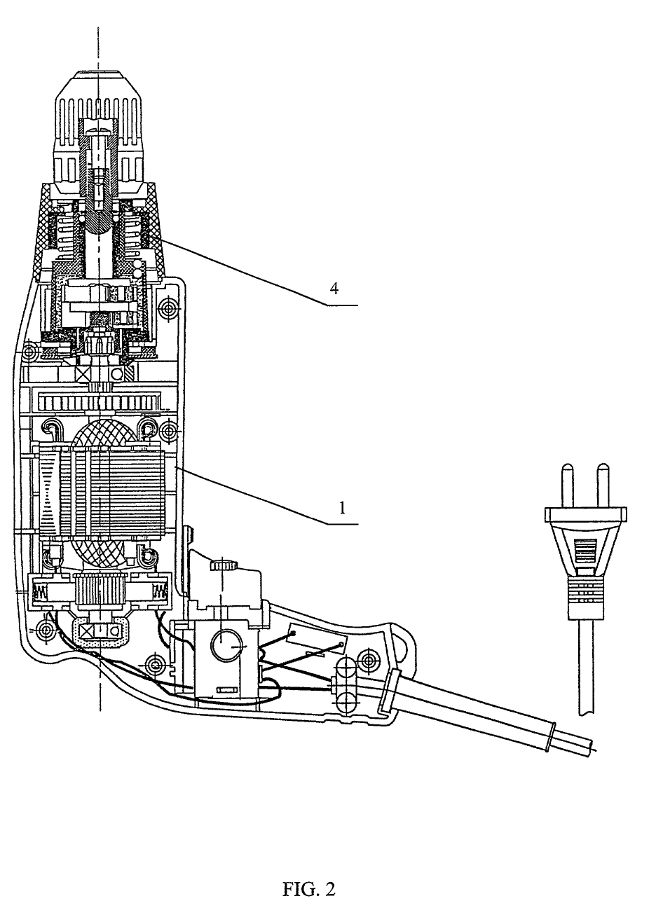

FIG. 2 is a combined structural view of the main body and the tool head of the AC power tool.

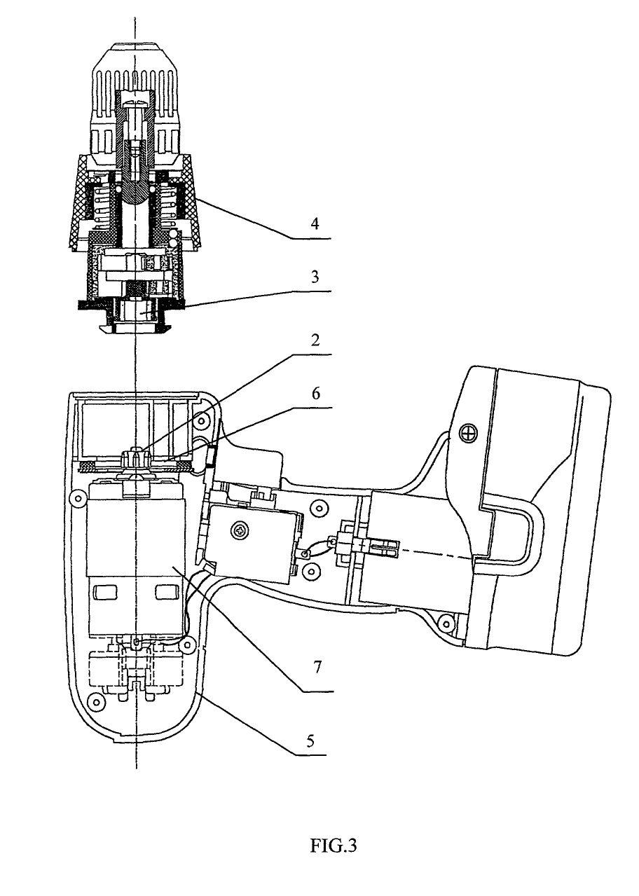

FIG. 3 is an exploded structural view of the main body and the tool head of the DC power tool.

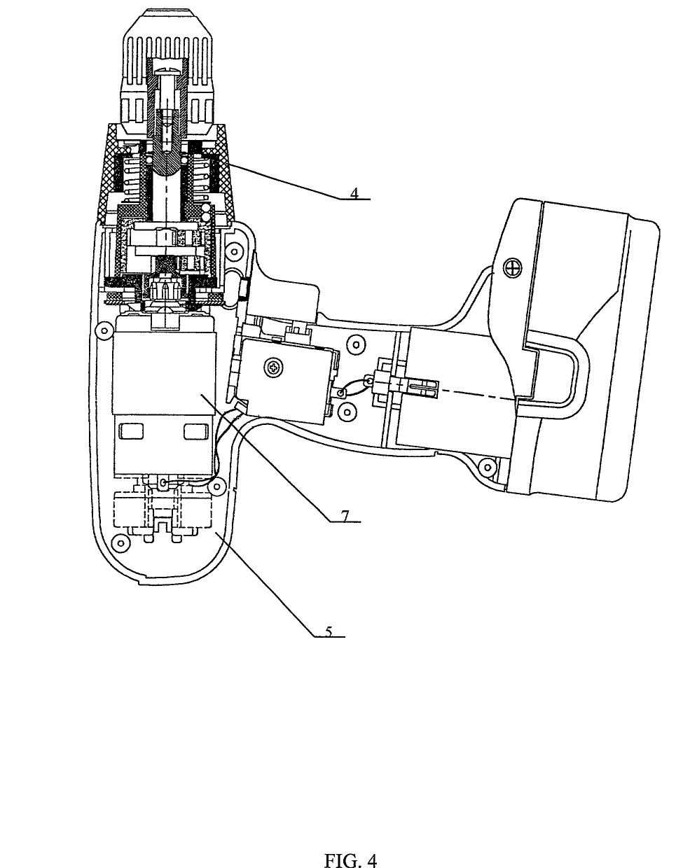

FIG. 4 is a combined structural view of the main body and the tool head of the DC power tool.

Referring to FIG. 1 and FIG. 3, the main body 1 of AC power tool and a main body 5 of DC power tool are respectively combined with a variety of tool heads 4 in an interchangeable way. Both main bodies 1 and 5 are provided with outer spline 2 arranged on an extension end of a main shaft of electromotor 7, an axis of the outer spline is in alignment with that of the main shaft. A variety of tool heads 4 are provided with inner spline 3, one end of the inner spline 3 meshes with the outer spline 2 to incorporate as a whole as shown in FIG. 2 and FIG. 4, the other end of the inner spline is connected to a output shaft of the tool head 4, an axis of the output shaft of the tool head is in alignment with that of the main shaft of the electromotor. A locking mechanism 6, the same as that of Chinese Patent No.99239510.0, is arranged at the main bodies 1 and 5 of the AC power tool and the DC power tool to lock the variety of tool heads tightly. The variety of tool heads 4 can be replaced by tool members used for drilling, sanding, grinding and sawing etc.

1. An AC, DC interchangeable multipurpose combination power tool comprising a main body, a tool head and a locking mechanism, characterized in that a main body (1) of AC power tool and a main body (5) of DC power tool are combined with a variety of tool heads (4) in interchangeable way.

2. An AC, DC interchangeable multipurpose combination power tool as claimed in claim 1, characterized in that the main bodies (1), (5) of the AC power tool and the DC power tool are both provided with an outer spline (2) arranged on an extension end of a main shaft of the electromotor (7), an axis of the outer spline is in alignment with that of the main shaft.

3. An AC, DC interchangeable multipurpose combination power tool as claimed in claim 1, characterized in that a variety of tool heads (4) are all provided with an inner spline (3), one end of the inner spline (3) meshes with the outer spline (2), and the other end of the inner spline is connected to an output shaft of the tool head (4), an axis of the output shaft is in alignment with that of the main shaft of the electromotor.

4. An AC, DC interchangeable multipurpose combination power tool as claimed in claim 1, characterized in that both main bodies (1), (5) of the AC power tool and the DC power tool are provided with the same locking mechanism (6) to tightly lock up a variety of tool heads.

5. An AC, DC interchangeable multipurpose combination power tool as claimed in claim 1, characterized in that the tool heads (4) may be a variety of tool members used for drilling, sanding, grinding and sawing etc.
